(19) United States
(12) Patent Application Publication
(10) Pub. No.: US 2018/0025661 A1
(43) Pub. Date: Jan. 25, 2018

(54) EDUCATIONAL COMPUTER PUZZLE

(71) Applicant: Lynn Properties, L.L.C., New Orleans, LA (US)

(72) Inventor: William J. More, New Orleans, LA (US)

(73) Assignee: Lynn Properties, L.L.C., New Orleans, LA (US)

(21) Appl. No.: 15/658,274

(22) Filed: Jul. 24, 2017

Related U.S. Application Data
(60) Provisional application No. 62/365,871, filed on Jul. 22, 2016.

(51) Int. Cl. G09B 7/04; G09B 19/00; A63F 13/85; G09B 25/06; G09B 25/02; G09B 5/02; G09B 23/30

(52) U.S. Cl. CPC G09B 7/04; G09B 5/02; G09B 19/0061; G09B 23/30; G09B 25/06; G09B 25/02; A63F 13/85

(57) ABSTRACT

An educational tool provides for presenting a challenge to solve a puzzle game with multiple, differentiated levels of playing surfaces and puzzle pieces. A user may zoom dynamically in and out and shift between the levels of playing surfaces and/or puzzle pieces. A geographic map-based puzzle game may include multiple layers of a world level with an option for zooming to a continent level, with a further option for zooming to a country level with all of the options having the potential to provide various levels of specifics and information, etc. and further in or back out. Each level or playing surface and each puzzle piece may make educational elements available to the user, at the user's discretion. For example, in a map-based puzzle, each piece at the country level may also state the largest city and/or the capital of the country and also all important bodies of water surrounding each country along with name of the body of water for any waters surrounding the country.

### FIELD OF THE DISCLOSURE

The field of the present disclosure includes interactive and educational games and learning tools, typically operable on a computerized platform, whether it be a desk computer, laptop computer, I-phone or Android, etc., incorporating user input devices such as a keyboard or other symbolic input devices, a mouse and/or touchscreen operable by stylus or finger and/or other pointing devices, a display, a processor, a storage device, and/or a network interface. A typical application for the present disclosure is an educational tool that includes a challenge, such as a puzzle related game where a user may select a puzzle, typically from a variety of available puzzles and/or other challenges, and, within the puzzle, select and arrange pieces to attempt to fill-in and/or complete the puzzle for educational and/or entertainment purposes.

### BACKGROUND OF THE DISCLOSURE

Attempts to computerize games with a puzzle-piece arrangement component have had drawbacks for the users' experience and have failed to leverage the computer's capabilities for enhancing game-play and educational possibilities and benefits. Past attempts have provided for two-dimensional puzzle boards and pieces, effectively just simulating on a computer screen the same structure as is available in a cardboard or wooden puzzle. At least some of these attempts, in modeling map puzzles, e.g., a puzzle map of countries on a continent, have provided the pieces in a size determined by the relative size of the actual countries, resulting in some pieces being too small to be readable and/or, manipulable, and otherwise usable by the typical user, for example, having the country's name crammed into a too small space. Another negative is not being able to easily identify the boundaries of the countries and the very limited educational aspects of the puzzle.

Some attempts at modeling a solid puzzle on a computer have provided drag-and-drop functions for moving pieces, but this just mimics the picking up and positioning of solid pieces. Some attempts, e.g., of anatomy-based puzzles, have modeled the pieces with typical jigsaw-shapes rather than body-part-shaped, which provides less educational value.

### SUMMARY OF THE DISCLOSURE

An education tool that includes a challenge, e.g., a puzzle game in accordance with one or more embodiments of the present disclosure may provide multiple, differentiated levels of playing surfaces and puzzle pieces. A user may be able to zoom dynamically in and out and shift between the levels of playing surfaces and/or puzzle pieces. For example, a geographic map-based puzzle game may include multiple layers, such a world level with an option for zooming to a continent level, with a further option for zooming to a country level with all of the options having the potential to provide various levels of specifics and information, etc. and further in or back out, etc.; a body-based puzzle game may include a level for selection of different animals or a human, a level for selection of the sex of the animal or human, a body level, an organ level, etc., with zooming between the levels; a mechanical structure-based puzzle game may include a level for selecting among various types of structure, e.g., cars, and then selecting a system level, and then selecting a components levels, with zooming as above. Other structures may include computers, televisions, radios, air planes, and various types of other equipment or things etc. Any of these examples may alternatively provide additional or fewer levels.

Each level or playing surface and each puzzle piece may make educational elements available to the user, at the user's discretion. For example, in a map-based puzzle, each piece at the country level may also state the largest city and/or the capital of the country and also all important bodies of water surrounding each country along with name of the body of water for any waters surrounding the country.

The size and color of puzzle pieces and text and other information associated with puzzle pieces may be selected, and may be alterable by the user, for improved user manipulability, legibility and flexibility of use. One or more embodiments of the present disclosure make use of drag-and-drop capabilities, but with improvements in user engagement and education.

Use of an educational/entertainment tool in accordance with one or more embodiments of the present disclosure may commence with the tool presenting to the user options for selecting a subject, such as a world map with an outline of each continent and an outline of each country within each continent, or a human body with an outline of organic systems of the body and an outline of each organ within each system. In response to the user selecting a continent or organic system, the tool may focus and zero in on such continent or system. The user may commence the challenge or puzzle-solving on that portion of the world map or human body or other subject.

The tool may control the screen for cursor operation, for example in the map context, such that as the user moves the cursor to the north, south, east or west, the world map moves and adjusts appropriately on the world map, causing the outline of the continent to the north, south, east or west to appear on the perimeter, along with the applicable bodies of water contiguous to it, depending on the area in which the cursor has moved. This approach and methodology may be applied for all aspects of global, flat, or round maps, and to human body and other subjects of a puzzle.

When presented on a screen, components of the puzzle may be arranged with pieces on one side of the screen and a blank solution area in an outline format on the opposite side of the screen. For example, on the right hand side of the screen, using about two-thirds of the entire screen, the tool would present a world map or human body or other solution area that is blank other than to contain an outline of the solution space and perhaps an outline of various major components such as the countries, continents, and/or the outline of organs of the body or other major parts of an object; and on the left hand side, using the remaining one-third of the entire screen, the tool would present the pieces to the challenge or puzzle.

A particular puzzle, such as one depicting the human body or a world map, may include pieces of disparate sizes, i.e., with surface areas varying by orders of magnitude. An automated zooming feature may be incorporated into the tool to account for this and provide a more user-friendly interface. The tool may allow the user to see more readily the details of such countries by allowing the smaller country pieces (or smaller organs etc.) to enlarge as they are dragged from the left side to the solution area.

Likewise, the tool may, as the user moves each smaller country closer to placement in the solution area, reduce the piece to its nominal size for proper location within the solution area. Correspondingly for puzzle pieces depicting larger countries, the map and/or the piece can be zoomed out to the entire continent and/or piece.

The puzzle may also incorporate an automated panning feature. Such feature may moving the selected puzzle piece to an approximation of the solved location, as appropriate for the selected level of puzzle difficulty.

The tool may maintain a distinction between countries, where feasible, by presenting the countries in a color representing characteristics of the country, e.g., green for lushness, brown for barrenness etc. along with having some texture for distinction.

### BRIEF DESCRIPTION OF THE DRAWINGS

FIG. 1 shows an opening screen presented by the tool of the present disclosure.

FIG. 2 shows a screen presented by the tool for user selection of a particular puzzle from a global world view.

FIG. 3 shows additional options on the screen of FIG. 2 including settings options.

FIG. 4 shows additional options on the screen of FIG. 2, including a player performance metric.

FIG. 5 shows additional options on the screen of FIG. 2, including interactive features of the global world view.

FIG. 6 shows additional options on the screen of FIG. 2, including the results of the user moving the cursor over a particular selectable puzzle.

FIG. 7 shows a screen presented by the tool for solving a particular puzzle with the puzzle pieces in a virtual container and a solution area to which to move the pieces.

FIG. 8 shows a screen with a different format than FIG. 7, also presenting the particular puzzle for solving.

FIG. 9 shows the screen of FIG. 7 as the user selects a puzzle piece to move to the solution area.

FIG. 10 shows the screen of FIG. 7 with the puzzle partially solved.

FIG. 11 shows the screen of FIG. 8 with the puzzle completely solved.

FIG. 12 shows a cursor hovering over a puzzle piece for a virtual container format similar such as the virtual container of FIG. 8.

FIG. 13 shows a master map for the game.

FIG. 14 shows an alternative master map for the game, with more geographical detail.

FIG. 15 shows an alternative representation of a globe that may be used in the tool.

FIG. 16 shows an embodiment in accordance with the present disclosure for an opening menu screen of a puzzle based on maps of continents.

FIG. 17 shows the puzzle of FIG. 16 with the map and puzzle pieces for South America.

FIG. 18 shows the map and puzzle pieces for South America puzzle of FIG. 16 partially solved.

FIG. 19 shows an embodiment in accordance with the present disclosure for an opening menu screen, formatted as a globe, for a puzzle based on maps of continents.

FIG. 20 shows a continental map puzzle with an option for manually positioning and sizing each of the country labels.

FIG. 21 shows a continental map puzzle with an option for cancelling a placement of a piece.

FIG. 22 shows an alternative embodiment for the solving-progress scoring with a visual bar indicating the progress along with the numerical score.

### DETAILED DESCRIPTION OF THE DISCLOSURE

An educational and/or entertainment tool in accordance with one or more embodiments of the present disclosure may provide a challenge presented as a puzzle to a user for learning about any amenable subject. As an initial menu, the tool may offer options, for selecting different types of puzzles, for example, human body or geographic map. Any type of menu, drop-down, list, chart, wheel, etc., with or without a visual representation of the options, may be used. On selecting a type of puzzle, if that is offered, for example, a computer-implemented, drag-and-drop, geography puzzle based on a world map, the tool may include an option of selecting any of the continents. Selecting one of the continents, for example by clicking on it, may result in an outline appearing, for starting purposes, of that particular continent with all of the various countries of that particular continent on the sidelines for insertion. For example, on a world map, the user may click on “South America,” resulting in an outline of South America appearing. The outline of the continent provides a solution area into which the user may move the puzzle pieces which in this instance would be countries.

A puzzle implemented on a computerized platform may be programmed in any manner suitable for the platform and any other electronic devices coupled to the platform. For example, implementing the puzzle on a computer with an OS such as Windows connected to a network may make use of a database system, such as the open source, object-relational database system known as PostgreSQL. The implementation may incorporate programming in languages, e.g., the PL/pgSQL procedural language, which may be integrated with the functionality of the database system. The tool may take a GIS-based approach to building a map-based puzzle. Geospatial data may be imported into the PostgreSQL database with the PostGIS extension, and may be stored as multi-polygon data which contains the various polygons that make up each country's data. If the original data source for country borders contains more detailed polygons than is necessary for gameplay, the borders may be simplified using the PostGIS st_simplifyPreserveTopology function, which reduces the number of points in the polygon using the Douglas-Peucker algorithm.

The data may be stored locally on a server that may also host a user-facing website for the game.

Puzzle pieces representing the various countries may be provided by the game in a variety of manners. For example, they may be displayed to one side of the continent outline and available dragging and dropping purposes. The pieces may be presented in a virtual container in one or more of various formats, such as a bank format, a carousel wheel format, a full screen hover format, or any other suitable format, with scrolling options as suitable to the particular set of puzzle pieces.

When the user places a puzzle piece in a proper location and orientation in the solution area, the tool may identify such piece as part of the solution, for example retaining the piece in its location in the solution area. The tool, in response to the user's placing a piece with incorrect location or orientation may advise the user, for example by returning the piece to the virtual container of pieces.

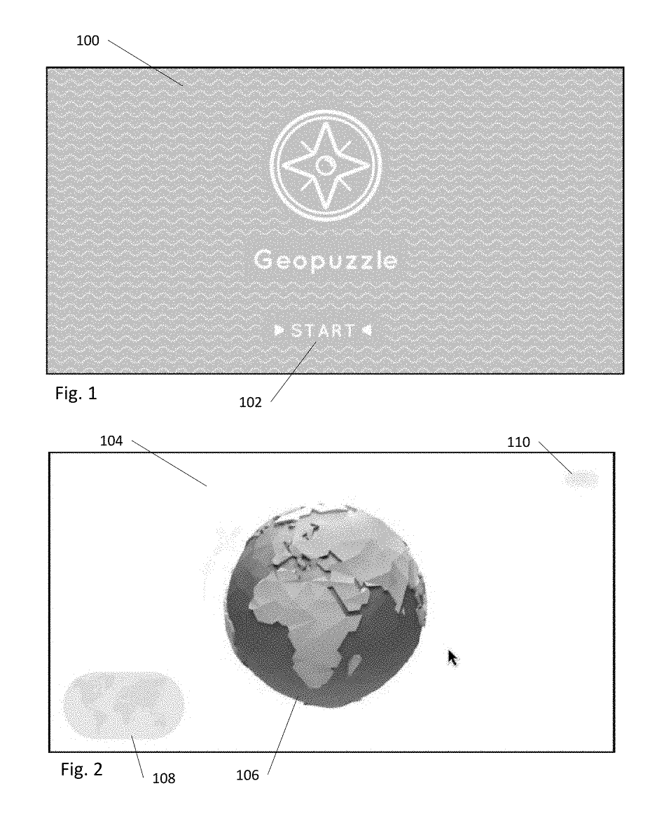

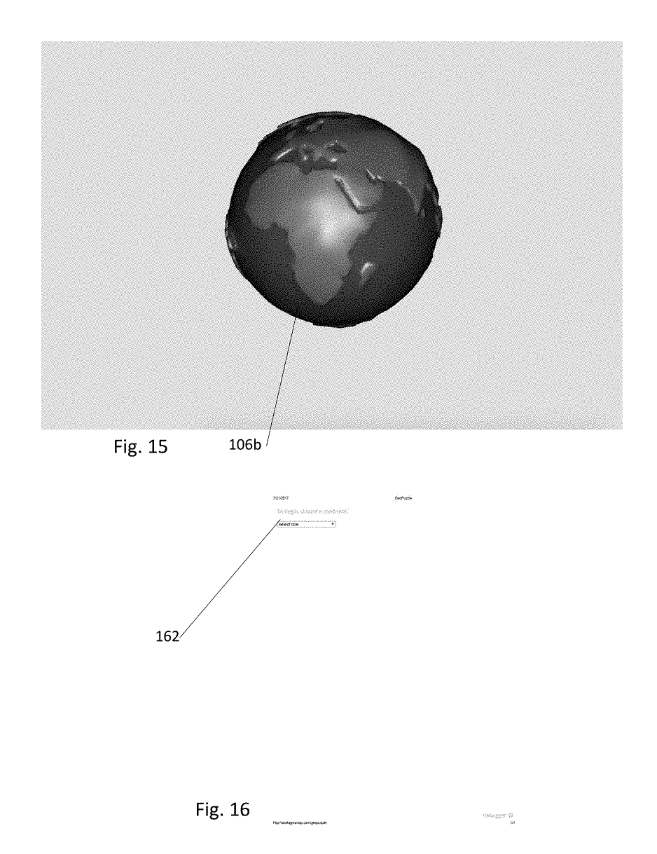

An example start screen 100 for the tool is shown in FIG. 1. The tool presents a prompt 102 to the user to start the puzzle solving operation. Alternatively, or in addition, the start screen may include log-in and sign-up or registration options that may be useful in online applications. The tool in response to the user selecting start through, e.g., mouse operation, may present a puzzle selection screen, such as a world view menu 104 as shown in FIG. 2. The puzzle selection screen may include a globe 106, with which the user may interact, for example to select a continent or other portion of the globe to start a map puzzle. The tool may provide for the globe to be rotatable by the user to display and/or the tool may animate the globe, e.g., to rotate on its own until the user makes a selection. As shown in FIG. 2, globe 106 (and also globe 106a in FIG. 15) may be provided with a three-dimensional appearance. The tool may also make available a selectable alternative views, e.g., flat world map 108 of the possible puzzles available within the tool for the user to select or perhaps another subject such as the human body or an automobile etc. The tool may also provide a menu selection button 110, typically for controlling other aspects of the tool operations, such as the settings of tool parameters.

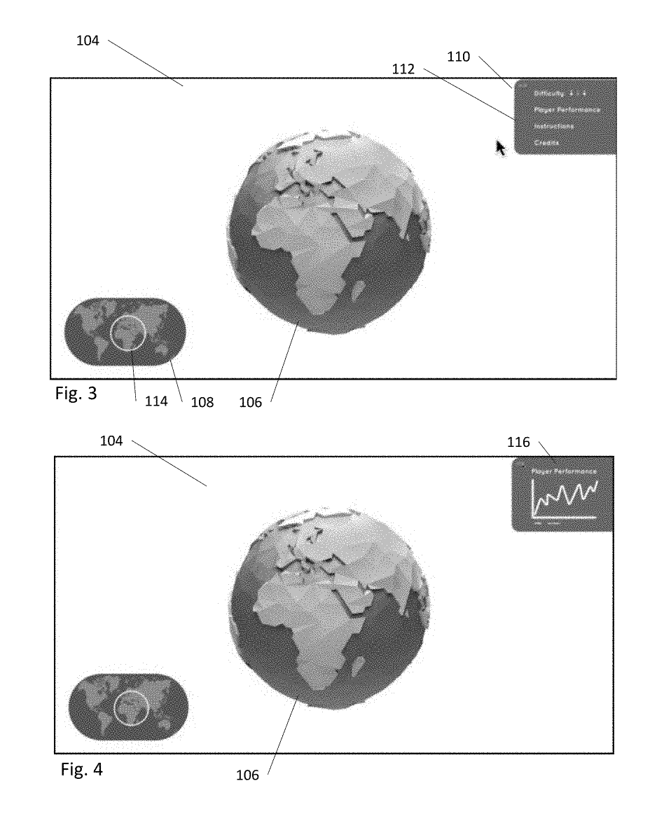

Examples of settings are shown in FIG. 3 where menu 110 has expanded into selectable options, such as difficulty levels, a player performance report, instructions, and credits. FIG. 3 also illustrates that the flat world map may display an indicator, such as a circle 114 correlating the portion of the world currently displayed on the globe with the same portion on the flat map.

The selector for difficulty may incorporate multiple levels of play and may be capable of supporting users of very different age and skill levels. As an example, three different levels of play can be easy, medium, and hard. In easy mode, the game can be played like a simple puzzle that requires no knowledge of geography. Pieces can be placed simply by looking at their shape and the available shapes on the puzzle. Small countries may be removed, so that every country's space is visible without zooming. This level should be playable by just about anyone that can use a computer, tablet, etc. In medium mode, users may need to know or to look up where a particular country is in order to place it on the map. In the case of smaller countries, the map may dynamically zoom to the appropriate level, and pan to the appropriate location on the map to hint to the user where to drop the piece. In hard mode, play is similar to medium mode, except that the user is responsible for zooming and panning the map to the appropriate location. In the case of small countries, e.g., Andorra, the user will need to zoom in on the border between Spain and France to see the space for the country, instead of the map providing the hint via zoom and/or pan. Medium mode may also present no border for the country so the user has to move to the correct location without the pattern matching that the display of the border allows. In hard mode, the user may need to provide the name of the country, rather than the name being displayed with the puzzle piece or in the solution area.

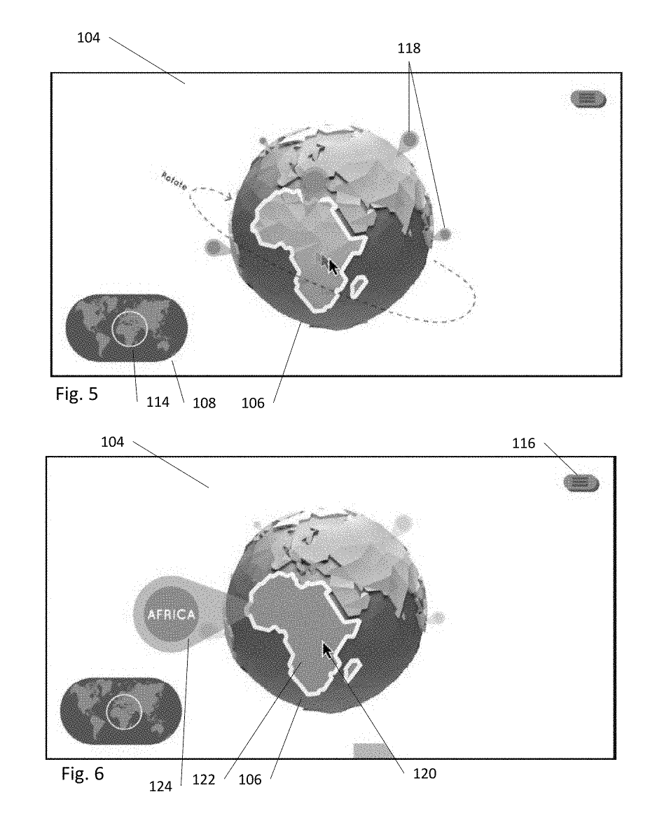

FIG. 4 shows an example of a player performance chart 116, which the tool may provide to track a particular user's progress, e.g., tracking, over time, the speed and/or accuracy with which the user solves the puzzle. FIG. 5 shows, as noted above, that the globe may be rotatable by the user, and/or rotate on its own, and additionally may show one or more user-selectable nodes 118, as to which, if the user selects, the tool may provide additional information about the location represented by the globe at each node.

A user's selection of a particular puzzle may begin, as shown in FIG. 6 as an example, by the user moving a cursor 120 over a location of a puzzle, e.g., a continent 122 such as Africa. The tool may highlight the continent over which the cursor is hovering to indicate the selectable puzzle and/or by providing additional information, such as displaying a pin with the continent name as illustrated in FIG. 6. Alternatively, or in addition the continent name may be displayed at the top of the screen or other location adjacent to the globe.

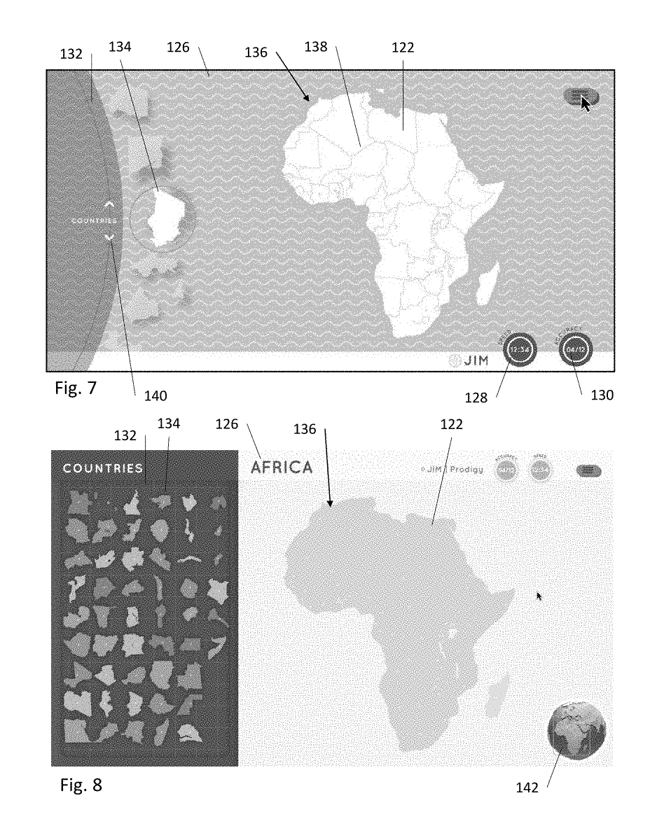

Typically, when the user selects a puzzle, such as continent 122, the tool will provide a transition to a view 126 of that continent as shown in FIG. 7. The tool may animate the transition, e.g., by zooming in to the continent and presenting information about the continent in text and/or other formats for educational and other purposes, and then displaying puzzle view 126. The transition may also incorporate a get-ready screen and/or a countdown timer for the user to start solving the puzzle. The tool may display metrics of the user performance, such as a timer 128 for tracking puzzle solving time and a counter 130 for tracking accuracy in the placement of puzzle pieces. The tool may also provide a screen explaining the basics of the game, and/or pointing out the clock and timer and/or additional help screens.

FIG. 7 shows a virtual container 132, such as a country bank, for a set of puzzle pieces 134 for the user to move to a solution area 136, e.g., at continent 122. The example in FIG. 7 includes within the solution area a set of lines 138 representing the boundaries of each country within the continent, which lines may or may not be displayed depending on, e.g., the selected difficulty level. Virtual container 132 may present puzzle pieces in various formats, such as the carousel format shown in FIG. 7, which includes up and down arrows 140 selectable by the user to move among the selectable puzzle pieces.

Another example of how puzzle pieces may be presented in virtual container 132 and may be movable to solution area 136 is shown in FIG. 8. Virtual container 132 may be in a grid format and the grid may expand and/or scale as the user moves pieces 134 into solution area 136. For example, when all the countries are in the virtual container, they will all be represented by the smallest available icons, and when half the countries have been correctly placed in the solution area, the grid space will be the same size with each icon for each country scaled twice as large. When only two countries remain in virtual container 132, each icon will take up 50% of the grid space, etc. FIG. 8 also illustrates a global view insert 142 where the tool provides to the user an indication of where on the globe the selected puzzle is located.

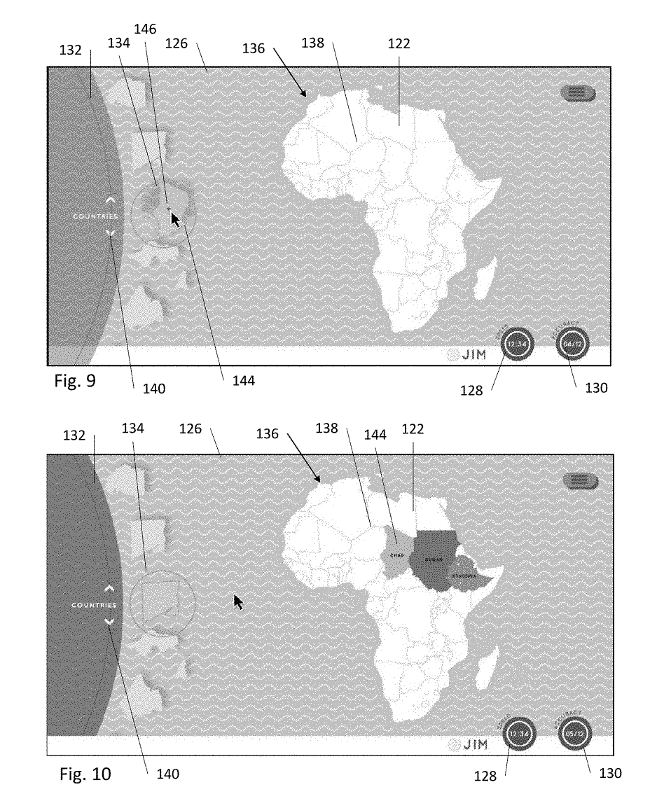

FIG. 9 illustrates that the tool may allow the user to select a puzzle piece, such as Chad 144. The tool may indicate the selection by highlighting or changing the color saturation of the country, and/or by turning on a locator, such as cross 146 within the piece, and allowing the user to move the selected piece toward the solution area. The tool may display each country in the bank in a common size, and then may scale each country to its appropriate size within the map as the user moves it from the bank toward the map. The tool may also display corresponding locators in the solution area to indicate possible locations for each piece. The tool may display locators for all possible locations or a subset, depending on user-selected difficulty level.

Typically, the operation for moving pieces to the solution area makes use of drag-and-drop functionality, and if the user drops the piece in an incorrect location, the tool may return the piece to container 132 and/or otherwise indicate the incorrect location, e.g., by darkening the country's color. The tool may record an unsuccessful attempt in the accuracy counter. As the user drags and drops pieces in correct locations, they will remain in the location in the solution area, as shown in FIG. 10. The tool may incorporate snapping the pieces to the exactly correct location when the user has moved the country close to the exact location, and may also otherwise indicate a correct location, e.g., by border or color changes. The tool may provide an option for cancelling a successful piece drop and return to the bank area.

A completed map appears as in FIG. 11 with container 132 empty and all of the pieces in solution area 136. The tool may also provide an informational finish screen (not shown) indicating the time and score and other puzzle-solving information. FIG. 11 also illustrates that textual information related to each piece, such as the country name, may appear in different sizes. For example, text may appear at 4 different sizes depending on the country: 36 pt, 24 pt, 14 pt, 9 pt.

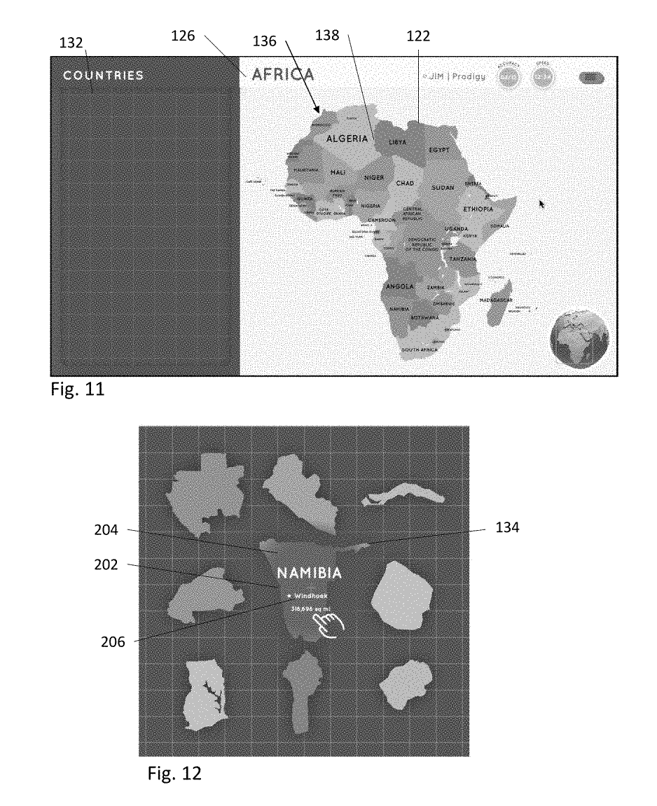

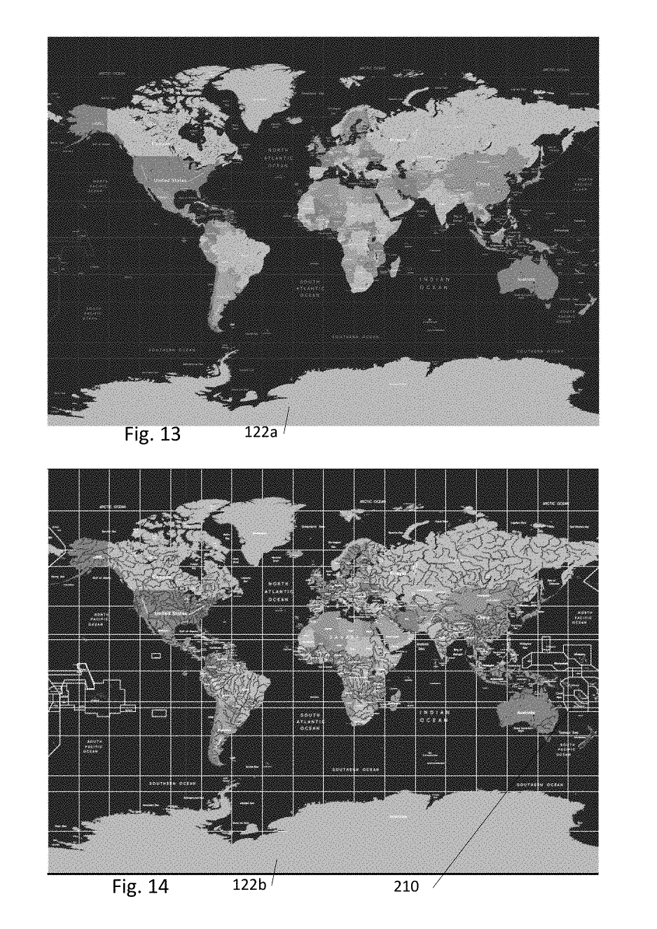

FIG. 12 shows a cursor 120a hovering over a puzzle piece 134a, in this example for a virtual container format as shown in FIG. 8. For this example, the tool's response to the user's hovering of cursor 120a over puzzle piece 134a is a display 202 with a background 204 directly over the piece of information 206, which may relate to puzzle piece 134a. Display 202 of information 204 may alternatively be adjacent to piece 134a and/or without background 204. FIG. 13 shows a master map for the game, which may incorporate a puzzle 122a representing the entire world.

FIG. 14 shows an alternative master map for the game, incorporating a puzzle 122b with more geographical detail. For example, puzzle 122b may include latitude and longitude lines and identifications of island groupings 210. A model of the world and other geographical entities may make use of data from geographical information systems (GIS). The geographical date may include geospatial data, such as country borders, and additional information such as rivers, land climate, important cities, and other features. The human body puzzle, and other types of puzzles may incorporate corresponding information.

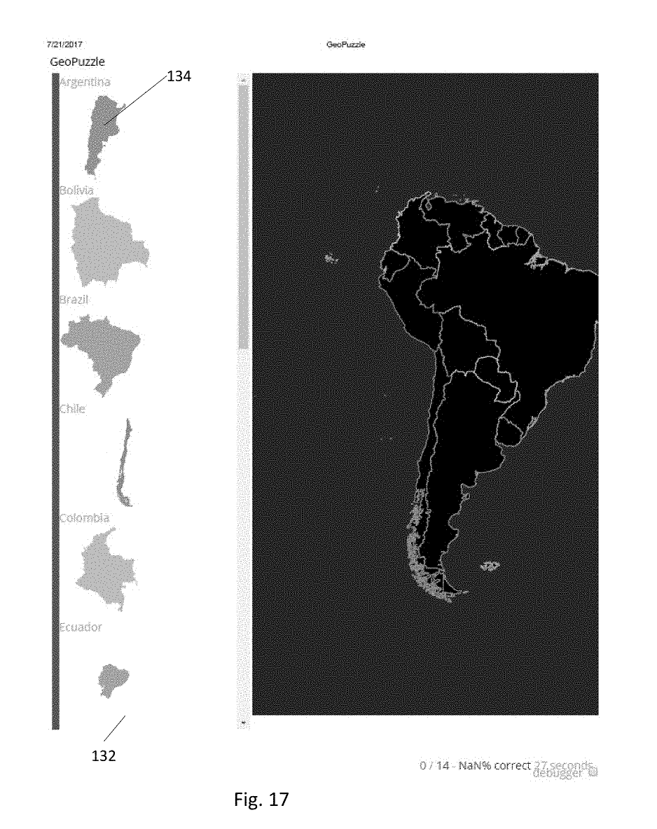

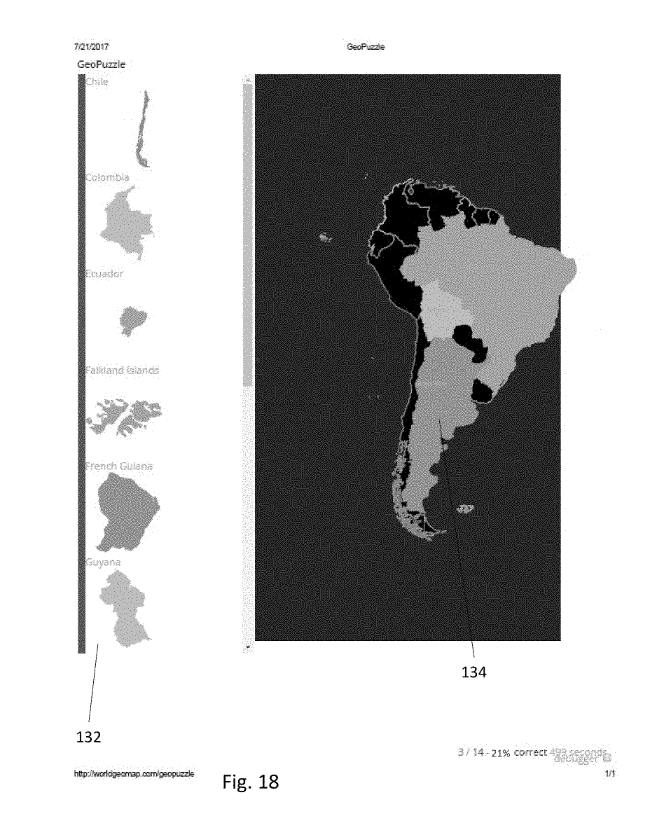

FIG. 16 illustrates another embodiment of the present disclosure with a continent-selection screen 160 with a drop-down menu 162. FIGS. 17 and 18 illustrates the embodiment of FIG. 16 with the puzzle for the continent of South America selected. FIG. 17 illustrates the puzzle before any attempt at solving. FIG. 18 illustrates that the tool may allow the user to move a puzzle piece, such as Argentina 144 into the South American continent map, and, if the user properly locates the puzzle piece within a tolerance for the country boundaries, the tool may retain the piece in the solved location and update the solution score to indicate progress toward complete solution. As for other embodiments, the selection of a piece may be indicated by highlighting or changing the color saturation of the country, and/or by turning on a locator, such as a cross (not shown) within the piece, and allowing the user to move the selected piece toward the solution area. The tool may display each country in the bank in a common size, for example, scaled to each fit within a bounding box of the same size. When a country is selected from the piece bank, it may be scaled to the same scale level as the puzzle/map, as appropriate to its size within the map as the user moves it from the bank toward the map. The tool may also display corresponding locators in the solution area to indicate possible locations for each piece. The tool may display locators for all possible locations or a subset, depending on user-selected difficulty level.

Typically, the operation for moving pieces to the solution area makes use of drag-and-drop functionality, and if the user drops the piece in an incorrect location, the tool may return the piece to container 132 and/or otherwise indicate the incorrect location, e.g., by darkening the country's color. The tool may record an unsuccessful attempt in the accuracy counter. As the user drags and drops pieces in correct locations, they will remain in the location in the solution area, as shown in FIG. 18. The tool may incorporate snapping the pieces to the exactly correct location when the user has moved the country close to the exact location, and may also otherwise indicate a correct location, e.g., by border or color changes.

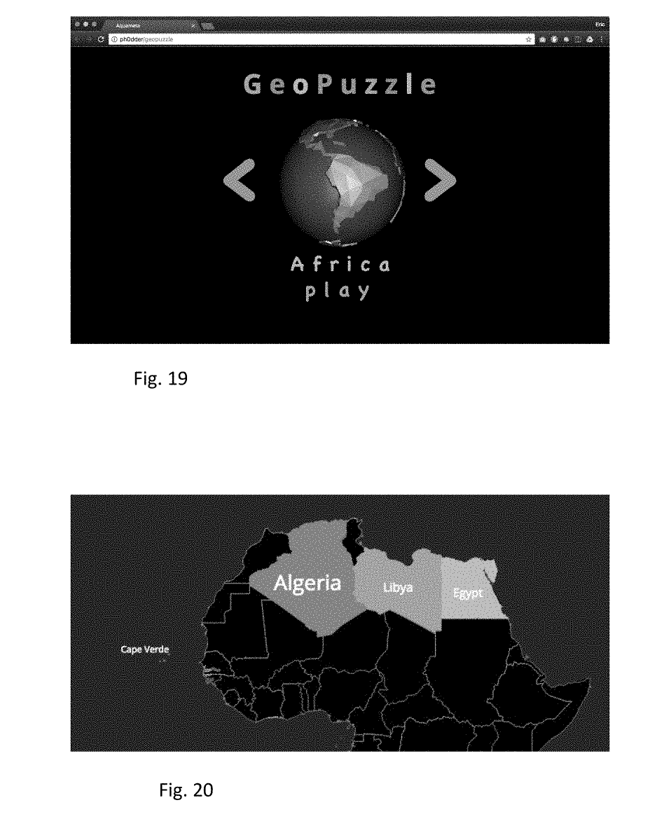

FIG. 19 illustrates the tool with an opening menu screen, formatted as a globe, for a puzzle based on maps of continents. Clicking left and right on the arrows changes the globe to the next continent. Clicking on play starts the puzzle solving phase.

FIG. 20 illustrates a continental map puzzle with an option for manually positioning and sizing each of the country labels. Each of these country labels can be manually positioned and sized. For example, by shift-clicking on a country, the country is highlighted and you enter “design mode,” in which the “+”and “−” keys change the scale of the country's font size; the arrow keys may be used to position the label; hitting “c” changes the color of the country and “x” exits designer mode.

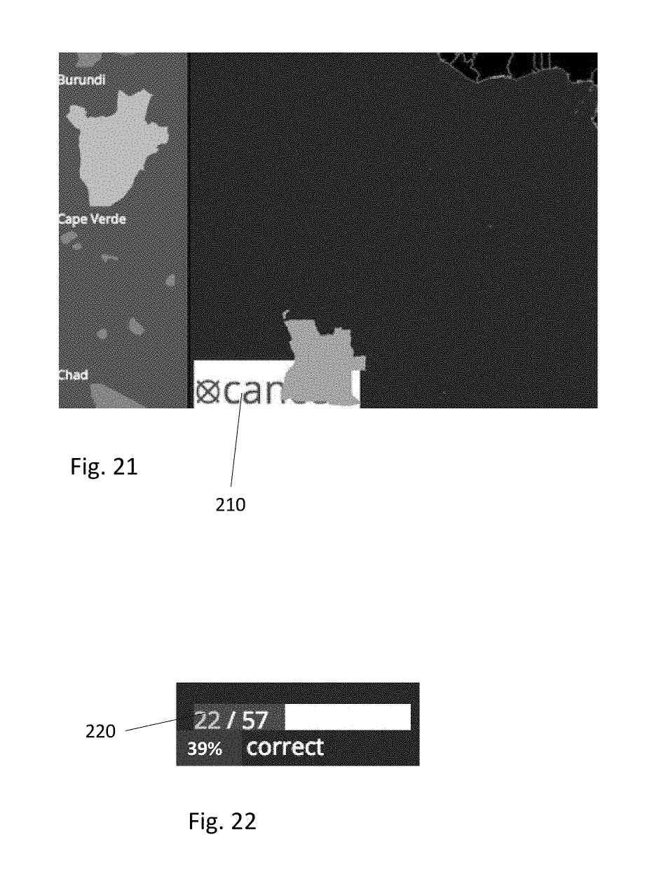

FIG. 21 shows a continental map puzzle with an option for cancelling a placement of a piece. Dragging a piece into a cancellation area 210 cancels the placement. A canceled placement does not count against the user's score.

FIG. 22 shows an alternative embodiment for the puzzle's display of the scoring, with a visual bar 220 indicating the progress toward solution, along with the numerical score.

A puzzle in accordance with the present disclosure may incorporate topographic and/or cartographic raster images to facilitate gameplay and/or to provide the additional information such as rivers, land climate, etc. For example, an additional graphical layer may be provided on the puzzle pieces, the layer made up of slices of a cartographically designed map. The layer may be rasterized onto the appropriate piece at runtime. Alternatively, these features could be algorithmically generated, although that may be associated with a lower level of quality, as compared to the rasterized layer.

On completion of a puzzle the tool may provide the user with feedback on the puzzle solving, such as speed, accuracy, and improvement over time, as described above. The tool may provide the user with an option to redo the puzzle or to quit the puzzle.

In one or more embodiments of the present disclosure, some or all of the countries would be in proportionate sizes to each other so that the countries would be totally representative of their size when compared to others. However, since some countries are very small, as the user drags the country from the container to insert into the continent outline, the smaller countries when selected may expand somewhat to a larger size to make them more readable, and then gradually reduce to its smaller size as the user approaches placing the country into the exact location of the country on the map.

At another level, the puzzle game may provide an outline of the world where the user may drop the various continents or other masses of land or bodies of water in various levels of detail into the outline of the world. The puzzle game may provide the world outline in a flat dimension, according to various projections, or in a global 3-dimensional representation, or be selectable among the various projections and representations.

Puzzle pieces may be provided with associated details to a greater or lesser extent according to the particular application, typically providing various degrees of complexity and zooming capacity, for example including in the map-based puzzle descriptions of the various geographical places. As another example of associated details, the country's land size and its population along with the percentage of its size and population to the rest of the world may be provided in the body of each country, or to the side of it depending on design capacity, and/or this could be done via a pop up. Other educational aspects may include the tool's responding to the user's clicking on a country or a body of water or capital or city or other aspect of a puzzle component with more information on that particular country or body of water or capital or city or other aspect of a puzzle component. For example, the tool may respond to a user clicking on a country by displaying a basic facts section, such as country population, GDP, major imports and exports, natural aspects, religion, political system, agriculture, wars, geological faults, leaders, brief history, and whatever other facts are suitable to the desired educational experience. In an embodiment with access, e.g., by online network, to a resource such as Wikipedia, the tool may use that resource to retrieve the information and/or incorporate a browser window capability for access to the resource.

Colors, texture, iconography, and/or animation of the puzzle pieces, such as countries, may be correlated with aspects of the thing represented by the piece. For example, a country's terrain and/or environment may be represented, either while the piece is still in container 132 or when located in in the correct place in solution area 136.

A user-interface flow carrying out a map puzzle may include:

### 0.0: Opening Menu→(Press Play)

### A.0: World View Menu

A.1 Settings Menu
   A.1.1 Difficulty
   A.1.2 Player Performance/Grade
   A.1.3 Instructions
   A.1.4 Credits
A.2 North America
   A.2.1 Description Menu
   A.2.2 Connect with other player's menu
A.3 South America
A.4 Africa
A.5 Asia
A.6 Europe
A.7 Pacific Islands
A.8 All other land masses
A.9 All bodies of water

### B.0 Continent View

B.1 Settings/Pause
   B.1.1 Player Status
   B.1.2 Quit/Back to A.1
   B.1.3 Reset Round
   B.1.4 Sound On/Sound Off
   B.1.5 Back to Game
B.2 Scroll up
B.3 Scroll Down
B.4 Select Country from “Country Bank”
   B.4.1 Correct Answer: Country is placed on the Continent Map
   B.4.2 Wrong Answer: Country goes back to Country Bank
B.5 Completed Map

Game play may also incorporate various points awarded based upon the speed and accuracy of putting the puzzle together etc.

Alternatively, the user interface flow may include one or more of the following:

0.0: Opening Page w. Logo
Onboarding Pages
Login Pages

### A.0: Explore

A.1 Map View
   A.1.1 Filter
   A.1.2 Search
   A.1.3 Select Date
   A.1.4 Credits
   A.1.5 Change color: Dark/Light
A.2 Search
   A.2.1 Recent Searches
   A.2.2 Recommended
A.3 Select City/Filter
   A.3.1 Popular City
   A.3.2 Price
   A.3.3 Select date from Calendar

### B.0 Play

### C.0 Favorites

### D.0 Profile/Settings

The tool may change the information displayed to the user at different levels of zoom. For example, the tool may provide three scales in terms of the percent of zoom. At each of these three levels information will disappear and reappear. For example, at the 200-166.7% zoom display: countries, cities, capitals, ocean names, river names, lake names, islands, etc. are all displayed. At the 166.7%-133.3% zoom display: countries, major cities/capitals, major land forms, seas/ocean labels, major islands are all displayed. At the 133.3%-100% zoom display: countries, ocean labels, and significant land forms are displayed.

A challenge such as a human body-based puzzle may include a perimeter of a human body, selectable for either male or female, with the various body parts provided in a suitable format for dragging and dropping. Educational aspects may include clicking for information on a body part. The liver piece, for example, may include a click-accessible explanation of the purpose and functions of the liver, which may include the user controlling the level of detail as desired. Puzzle pieces may include shapes that are not possible or feasible with a solid structure, such as an arterial system or a venouse system in a human body-based puzzle, and multiple different layers or levels may allow the user to take a part of the body such as the heart and break it down into all of the valves, arteries and veins etc. This same concept and approach would be applicable for all other options of use regarding the world, body or others such as an automobile, computer or television, or other equipment or things etc.

Another option in the user interface may include the user's shifting from one puzzle to another, for example, from continent to continent and back, which may incorporate the country bank's expanding and shrinking in the number of continents it contains.

Another option in the user interface may include a mode in which the user is very directly guided by another game player or a teacher, or by a player-model or a teacher-model within the tool. For example, the teacher may give the player only 4-6 countries at a time and prompt the user to repeat this over and over, adding different layers of information about the countries in each round, then being promoted as the knowledge level of the user increases as identified by success in a round.

The following paragraphs may provide further information regarding illustrative versions of the above-described systems and methods related to the educational tool.

A0: A particular way of carrying out the puzzle of the present disclosure using a computer may include:
a challenge presented as a puzzle to a user via the computer with an option of selecting any of a plurality of continents, each continent providing a solution area into which the user may move one or more puzzle pieces representing countries;
the pieces presented in a virtual container in a format selected from the group of a bank format, a carousel wheel format, and a full screen hover format, and further including a scrolling option;
wherein the tool, in response to the user's placing a piece with incorrect location or orientation advises the user by returning the piece to the virtual container of pieces.

It is believed that the disclosure set forth herein encompasses multiple distinct inventions with independent utilities. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

While the computer puzzle and methods of applying educational features in a computer puzzle have been particularly shown and described with reference to preferred embodiments thereof, it will be understood by those skilled in the art that various other changes in the form and details may be made therein without departing from the spirit and scope of the invention. The foregoing description of the exemplary embodiments of the invention has been presented for purposes of illustration and description. It is not intended to be exhaustive or to limit the invention to the precise form disclosed. Modifications and variations are possible in light of the above teaching. It is intended that the scope of the invention be limited not with this detailed description but rather by the claims appended hereto.

The subject matter of the invention(s) includes all novel and nonobvious combinations and subcombinations of the various elements, features, functions, and/or properties disclosed herein. The following claims particularly point out certain combinations and subcombinations regarded as novel and nonobvious. Invention(s) embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the invention(s) of the present disclosure.

I claim:

1. A system for presenting an educational challenge to a user, the system comprising:
a computerized platform including a processor, a display coupled to the processor, and a user input device coupled to the processor;
wherein the processor is programmed to provide via the display a menu to the user with a selection of puzzles, each puzzle providing a virtual container area and a solution area, the puzzle further providing a set of puzzle pieces in the virtual container area and a set of solution locations in the solution area, each solution location corresponding to one of the puzzle pieces, and the processor further providing for the user to operate the user input device to move one or more puzzle pieces from the virtual container area to the solution area;
wherein the processor depicts on the display each puzzle piece in the virtual container area at substantially the same size, and wherein the processor evaluates a size of each solution location and adjusts the size of each puzzle piece as the user moves each puzzle piece from the virtual container area to the solution area, the processor further matching the size of each puzzle piece to the solution location when placed in a correct location; and
further wherein the processor, in response to the user's placing a piece in an incorrect location advises the user by returning the piece to the virtual container area.

2. The system of claim 1 wherein the processor, in response to the user's placing a piece in an incorrect orientation advises the user by returning the piece to the virtual container of pieces.

3. The system of claim 1 wherein the computerized platform is selected from the group consisting of a desk computer, a laptop computer, and a smartphone.

4. The system of claim 1 wherein the user input device is selected from the group consisting of a keyboard, a mouse, and a touchscreen

5. The system of claim 1 wherein the menu presents a representation of a globe representing Earth.

6. The system of claim 1 wherein the menu presents a representation of a human body.

7. The system of claim 1 wherein the menu presents a representation of a mechanical system.

8. The system of claim 1 wherein the menu presents the selection of puzzles includes a representation of a globe representing Earth, a representation of a human body, and a representation of a mechanical system.

9. The system of claim 1 wherein at least one of the puzzles is a map of countries on a continent, and wherein the pieces are represented in the virtual container with a border.

10. The system of claim 1 wherein at least one of the puzzles is a map of countries on a continent, and wherein the pieces are represented in the virtual container without a border.

11. The system of claim 1 wherein the processor further depicts a cancellation area on the display and, if the user moves a puzzle piece to the cancellation area, the processor returns the puzzle piece to the virtual container area.

12. The system of claim 1 wherein the processor further depicts a visual bar on the display representing the user's progress toward solving the puzzle.

13. A system for presenting an educational challenge to a user, the system comprising:
a computerized platform including a processor, a display coupled to the processor, and a user input device coupled to the processor;
wherein the processor is programmed to provide via the display a set of options for selecting among more than one subjects for puzzle-solving, wherein the subjects include a world map with an outline of each continent and a human body map with an outline of organic systems of the body,
wherein the processor, in response to the user selecting a subject, displays the corresponding map providing one or more puzzles, and,
further wherein the processor provides, in response to the user selecting a puzzle within the selected map, a virtual container area and a solution area for a puzzle corresponding to the map, the puzzle further providing a set of puzzle pieces in the virtual container area and a set of solution locations in the solution area, each solution location corresponding to one of the puzzle pieces, and the processor further providing for the user to operate the user input device to move one or more puzzle pieces from the virtual container area to the solution area;
wherein the processor depicts on the display each puzzle piece in the virtual container area at substantially the same size, and wherein the processor evaluates a size of each solution location and adjusts the size of each puzzle piece as the user moves each puzzle piece from the virtual container area to the solution area, the processor further matching the size of each puzzle piece to the solution location when placed in a correct location; and
further wherein the processor, in response to the user's placing a piece in an incorrect location advises the user by returning the piece to the virtual container area.

14. The system of claim 1 wherein the processor automatically pans the solution area as the user moves each puzzle piece from the virtual container area and across the solution area.

15. The system of claim 13 wherein processor displays the virtual container area in a format selected from the group consisting of a bank format, a carousel wheel format, and a full screen hover format.

16. The system of claim 13 wherein the processor represents the world map as a globe and further wherein the processor provides for rotating the globe via the user input device.

17. The system of claim 13 wherein the processor represents the human body map as a three-dimensional body and further wherein the processor provides for rotating the three-dimensional body via the user input device.

18. The system of claim 13 wherein the processor further provides a set of selectable difficulty levels, a player performance report, and a set of instructions.

19. The system of claim 13 wherein the processors depicts on the display, after the user selects a puzzle, a get-ready screen with a countdown timer to when the user will start solving the puzzle.

20. A system for presenting an educational challenge to a user, the system comprising:
a computerized platform including a processor, a display coupled to the processor, and a user input device coupled to the processor;
wherein the processor is programmed to provide via the display a menu to the user with a selection of puzzles, each puzzle providing a virtual container area and a solution area, the puzzle further providing a set of puzzle pieces in the virtual container area and a set of solution locations in the solution area, each solution location corresponding to one of the puzzle pieces, and the processor further providing for the user to operate the user input device to move one or more puzzle pieces from the virtual container area to the solution area;
wherein the processor depicts on the display each puzzle piece in the virtual container area at substantially the same size, and wherein the processor evaluates a size of each solution location and adjusts the size of each puzzle piece as the user moves each puzzle piece from the virtual container area to the solution area, the processor further matching the size of each puzzle piece to the solution location when placed in a correct location; and
further wherein the processor, in response to the user's placing a piece in an incorrect location advises the user by returning the piece to the virtual container area, and further wherein the processor, in response to the user's placing a piece in an incorrect orientation advises the user by returning the piece to the virtual container of pieces, and further wherein the processor depicts a cancellation area on the display and, if the user moves a puzzle piece to the cancellation area, the processor returns the puzzle piece to the virtual container area, and further wherein the processor further provides a set of selectable difficulty levels, a player performance report, and a set of instructions.
